(19) United States
(12) Patent Application Publication
(10) Pub. No.: US 2025/0055084 A1
(43) Pub. Date: Feb. 13, 2025

(54) COIN-SHAPED BATTERY

(71) Applicant: Panasonic Intellectual Property Management Co., Ltd., Osaka (JP)

(72) Inventor: MASAO OOTSUKA, Osaka (JP)

(21) Appl. No.: 18/718,481

(22) PCT Filed: Oct. 6, 2022
(86) PCT No.: PCT/JP2022/037365

§ 371 Date: Jun. 11, 2024

(30) Foreign Application Priority Data
Dec. 24, 2021 (JP) 2021-211359

(51) Int. Cl. H01M 50/109; H01M 50/153; H01M 50/184; H01M 50/545

(52) U.S. Cl. CPC H01M 50/109; H01M 50/153; H01M 50/184; H01M 50/545

(57) ABSTRACT

A coin-shaped battery includes a power generation element and an outer housing hermetically accommodating the power generation element therein. The outer housing includes a case having an outer surface including a first terminal surface, a sealing plate having an outer surface including a second terminal surface, and a gasket. The case includes a bottom plate and a side wall. The sealing plate includes a top plate and a circumferential edge portion. The gasket is compressed and interposed between the side wall and the circumferential edge portion. The circumferential edge portion includes: a first wall portion extending in a direction from the top plate toward the bottom plate; a second wall portion extending in a direction from the bottom plate toward the top plate to compress the gasket between the second wall portion and the side wall; and a fold-back portion connecting the first wall portion to the second wall portion. A space is provided between the first wall portion and the second wall portion. A thickness of the gasket before compression is less than a thickness of the second wall portion.

### DESCRIPTION

### Technical Field The present disclosure relates to coin-shaped batteries.

### Background Art

Coin-shaped batteries each including a power generation element and an outer housing hermetically enclosing the power generation element are known (for example, PTL 1). The outer housing of the coin-shaped battery shown in PTL 1 includes a sealing plate, a closed-bottomed tubular case, and a gasket interposed between the sealing plate and the case. PTL 1 specifies respective compression rates at plural locations on the gasket.

### CITATION LIST

### Patent Literature

PTL 1: Japanese Patent Laid-Open Publication No. 09-283102

### SUMMARY

The coin-shaped battery of PTL 1 hardly has a sufficiently large internal space. A reason therefor is that a relatively thick gasket is necessary in order to accomplish the compression rates of the gasket as shown in PTL 1, so that a portion of the gasket that is not compressed unduly partly occupies the internal space of the coin-shaped battery. The internal space is preferably large to increase the capacity of coin-shaped batteries. An object of the present disclosure is to increase the internal space of coin-shaped batteries.

One aspect of the present disclosure relates to a coin-shaped battery. The coin-shaped battery includes a power generation element and an outer housing hermetically accommodating the power generation element therein. The outer housing includes a case having an outer surface including a first terminal surface, a sealing plate having an outer surface including a second terminal surface, and a gasket. The case includes a bottom plate and a side wall extending upward from the bottom plate. The sealing plate includes a top plate and a circumferential edge portion extending from the top plate toward inside with respect to the side wall. The gasket is compressed and interposed between the side wall and the circumferential edge portion. The circumferential edge portion includes: a first wall portion extending in a direction from the top plate toward the bottom plate; a second wall portion disposed outward with respect to the first wall portion, the second wall portion extending in a direction from the bottom plate toward the top plate such that the gasket is compressed between the second wall portion and the side wall; and a fold-back portion connecting the first wall portion to the second wall portion. A space is provided between the first wall portion and the second wall portion. A thickness of the gasket before compression is less than a thickness of the second wall portion.

According to the present disclosure, a coin-shaped battery with a large internal space is provided.

### BRIEF DESCRIPTION OF THE DRAWINGS

FIG. 1 is a cross-sectional view of a main part of a coin-shaped battery according to an exemplary embodiment of the present disclosure.

FIG. 2 is a cross-sectional view of the coin-shaped battery for illustrating dimensions of various parts of the battery.

FIG. 3 is a plan view of the coin-shaped battery.

### DESCRIPTION OF EMBODIMENTS

Hereinbelow, exemplary embodiments of a coin-shaped battery according to the present disclosure the present disclosure will be described with reference to examples. It should be noted, however, that the present disclosure is not limited to the examples described below. The following description may indicate specific numerical values and specific materials as examples, but it is possible to use other numerical values and other materials insofar as the advantageous effects according to the present disclosure are obtained.

A coin-shaped battery according to the present disclosure includes a power generation element and an outer housing. The coin-shaped battery according to the present disclosure may include a button-shaped battery. The coin-shaped battery may be, for example, a primary battery, such as a lithium primary battery, or a secondary battery, such as a lithium-ion battery and a lithium metal battery.

The power generation element includes a first electrode (for example, a positive electrode), a second electrode (for example, a negative electrode), a separator interposed between them, and an electrolyte.

The outer housing hermetically accommodates the power generation element therein. The outer housing includes a case, a sealing plate, and a gasket. The outer housing may hermetically accommodate the power generation element therein with the gasket compressed between the case and the sealing plate. The case and the sealing plate together surround and demarcate the internal space of the button-shaped battery. The power generation element is accommodated in the internal space.

The case includes a bottom plate and a side wall extending upward from the bottom plate. The bottom plate and the side wall may be formed unitarily in a single piece. The bottom plate is circular about a central axis, but may have a shape similar to a circular shape surrounding a central axis (for example, an elliptical shape). The angle formed by the bottom plate and the side wall may be, for example, greater than or equal to 85° and less than or equal to 95°, and may be 90°. The outer surface of the case includes a first terminal surface. The first terminal surface may be electrically connected to the first electrode of the power generation element, and may be a positive electrode terminal surface. The case may be made of a metal plate made of stainless steel (such as SUS430, SUS444, and SUS329J), titanium, titanium or alloys thereof.

The sealing plate includes a top plate and a circumferential edge portion extending from the top plate toward inside with respect to the side wall. The top plate and the circumferential edge portion may be formed unitarily in a single piece. The shape of the top plate corresponds to the shape of the bottom plate and may be a circular shape having a smaller radius than the bottom plate. The angle formed by the top plate and the circumferential edge portion may be, for example, greater than or equal to 93°, and may be greater than or equal to 95° and less than or equal to 110°. An outer surface of the sealing plate includes a second terminal surface. The second terminal surface may be electrically connected to the second electrode of the power generation element, and may be a negative electrode terminal surface. The case may be made of a metal plate made of stainless steel (such as SUS304 and SUS316), plain steel, or carbon steel. Plain steel is a steel such as SS material, SM material, and SPCC material, which are specified by JIS. Carbon steel is a steel such as S10C, S20C, S30C, S45C, and S55C, which belong to low-alloyed steels for machine structural use.

The gasket is compressed and interposed between the side wall of the case and the circumferential edge portion of the sealing plate. Examples of materials for the gasket may include resin materials, such as polypropylene (PP), polyphenylene sulfide (PPS), and polyether ether ketone (PEEK).

The circumferential edge portion of the sealing plate includes a first wall portion, a second wall portion, and a fold-back portion. The first wall portion, the second wall portion, and the fold-back portion may be formed unitarily in a single piece.

The first wall portion extends from a top plate end toward a bottom plate end. The first wall portion may extend toward an outside of the coin-shaped battery, that is, extend further away from the central axis and away from the internal space as extending from the top plate toward the bottom plate.

The second wall portion is disposed outward with respect to the first wall portion, i.e., further away from the central axis with respect to the first wall portion. The second wall portion extends from a bottom plate end toward a top plate end. The second wall portion compresses the gasket between the second wall portion and the side wall of the case. The second wall portion may extend along the side wall. The second wall portion may extend substantially parallel to the side wall. The phrase that the second wall portion and the side wall extend substantially parallel to each other means that the angle formed by the just-mentioned two portions is less than or equal to ±3°, and it is meant to include the case where the just-mentioned two portions extend strictly parallel to each other.

The fold-back portion connects the first wall portion to the second wall portion together. The fold-back portion may connect an end portion of the first wall portion facing the bottom plate end to an end portion of the second wall portion facing the bottom plate. The fold-back portion may be formed between the first wall portion and the second wall portion in a process of bending a plate so as to form the first wall portion and the second wall portion.

A space is provided between the first wall portion and the second wall portion. When the fold-back portion is formed and produces the space, so-called springback occurs noticeably at the fold-back portion. This springback produces a restoring force displacing the second wall portion away from the central axis and outward toward the side wall of the case. The gasket is provided on the outer circumferential side of the second wall portion, and the side wall of the case is provided outside the gasket. This configuration allows the gasket to be compressed over a wide area between the side wall of the case and the second wall portion that tends to be displaced outward. Therefore, even the gasket with a small thickness provides an excellent hermetically sealed structure of the coin-shaped battery by compressing the gasket over a wide region. Specifically, in the coin-shaped battery of the present disclosure, the thickness of the gasket before compression is less than the thickness of the second wall portion. This thin gasket has a small volume occupying the coin-shaped battery, and increases the internal space of the coin-shaped battery accordingly.

When coin-shaped batteries are used a low-temperature environment, the size of the gasket which is made of a resin material changes dimensionally resulting from shrinkage. Such dimensional changes may cause coin-shaped batteries with a conventional structure to have a gap between the gasket and the sealing plate or between the gasket and the case, resulting in electrolyte leakage. On the other hand, even if the gasket undergoes shrinkage under a low-temperature environment, the coin-shaped battery according to the present disclosure enables the second wall portion to accommodate the dimensional changes of the gasket due to the above-mentioned springback. Therefore, the coin-shaped battery of the present disclosure is unlikely to develop the gap even when using a thin gasket.

The thicknesses of the first wall portion and the second wall portion may be less than or equal to the thicknesses of the bottom plate and the side wall. The above-mentioned springback occurs more noticeably when the thickness of the material is smaller. Therefore, the configuration in which when the thicknesses of the first wall portion and the second wall portion is less than or equal to the thicknesses of the side wall of the case enhances the effect of the springback that occurs between the first wall portion and the second wall portion compared with the springback that occurs between the bottom plate and the side wall which is usually formed by bending a plate. When the effect of the latter springback is greater, the gasket is compressed more intensively between the second wall portion and the side wall. This configuration enhances the hermetically sealed structure of the coin-shaped battery.

The radius of curvature of the outer surface of the fold-back portion is greater than the radius of curvature of the outer surface of the bent portion between the bottom plate and the side wall. The above-mentioned springback occurs more noticeably when the radius of curvature (for example, the radius of curvature of the outer surface) of a portion of the material that is bent is greater. Therefore, when the radius of curvature of the outer surface of the fold-back portion is greater than the radius of curvature of the outer surface of the bent portion, the effect of the springback that occurs at the fold-back portion is greater than the springback that occurs at the bent portion. When the effect of the latter springback is greater, the gasket is compressed more intensively between the second wall portion and the side wall. This configuration enhances the hermetically sealed structure of the coin-shaped battery.

The angle formed by the first wall portion and the second wall portion may be greater than or equal to 3° and less than or equal to 20°. the angle greater than or equal to 3° sufficiently enhances the effect of the springback that occurs at the fold-back portion. In addition, the angle less than or equal to 20° prevents the hermetically sealed structure from becoming excessively large in size to provide a sufficiently large space for the internal space of the coin-shaped battery. The angle may be greater than or equal to 5° and less than or equal to 20°. The just-mentioned angle greater than or equal to 5° enhances the effect of the springback that occurs at the fold-back portion.

The expression H1×0.4≤L1≤H1×0.8 may hold, where H1 is the distance, along a height direction, between the outside main surface of the bottom plate and the outside main surface of the top plate, and L1 is the length, along a height direction, of a part of the gasket that is compressed by the side wall and the second wall portion. The term “height direction” refers to a direction perpendicular to the main surface of the bottom plate of the case. The part of the gasket that is compressed by the side wall and the second wall portion may correspond to a part where the side wall and the second wall portion extend substantially parallel to each other. When L1≥H1×0.4, the gasket is compressed by the side wall and the second wall portion over a sufficiently wide area.

The tip end portion of the side wall may be bent inward, i.e., toward the central axis, and may also compress the gasket between the tip end portion of the side wall and the second wall portion. This configuration allows the gasket to be compressed between the tip end portion of the side wall and the second wall portion, and enhances the hermetically sealed structure of the coin-shaped battery. Moreover, the second wall portion pressed by the tip end portion of the side wall prevents the sealing plate from removing from the case when, for example, the internal pressure of the coin-shaped battery rises.

The compression rate of the gasket between the second wall portion and the side wall may be lower than the compression rate of the gasket between the tip end portion of the side wall and the second wall portion. The compression rate referred to in the present description refers to the ration (C/T) of compression amount C with respect to thickness T of the gasket before compression at a compression location. For example, when a gasket with a thickness T of 1.0 mm before compression is compressed to a thickness of 0.7 mm (i.e., when the compression amount is 0.3 mm), the compression rate is 0.3 (=0.3/1.0). The compression rate of the gasket between the second wall portion and the side wall may be, for example, greater than or equal to 0.3 and less than or equal to 0.4. The compression rate of the gasket between the tip end portion of the side wall and the second wall portion may be, for example, greater than or equal to 0.5 and less than or equal to 0.6.

The gasket may be compressed between the fold-back portion and the bottom plate. The compression rate of the gasket between the second wall portion and the side wall may be lower than the compression rate of the gasket between the fold-back portion and the bottom plate. The compression rate of the gasket between the second wall portion and the side wall may be, for example, greater than or equal to 0.3 and less than or equal to 0.4. The compression rate of the gasket between the fold-back portion and the bottom plate may be, for example, greater than or equal to 0.5 and less than or equal to 0.6.

As disclosed above, the present disclosure provides a large internal space of the coin-shaped battery with a thin gasket. Furthermore, the present disclosure increases the capacity of the coin-shaped battery with such a large internal space.

An example of the coin-shaped battery according to the present disclosure will be detailed below with reference to drawings. The constituent elements of the example of the coin-shaped battery described below may use the constituent elements that have been described above. The constituent elements of the coin-shaped battery of the example described below may be modified based on the description described above. The matters described below may also be applied to the above-described exemplary embodiments. Of the constituent elements of one example of the coin-shaped battery described below, constituent elements that are not essential to the coin-shaped battery according to the present disclosure may be omitted. It should be noted that the drawings presented herein are merely schematic and do not necessarily reflect the actual shapes and numbers of the members accurately.

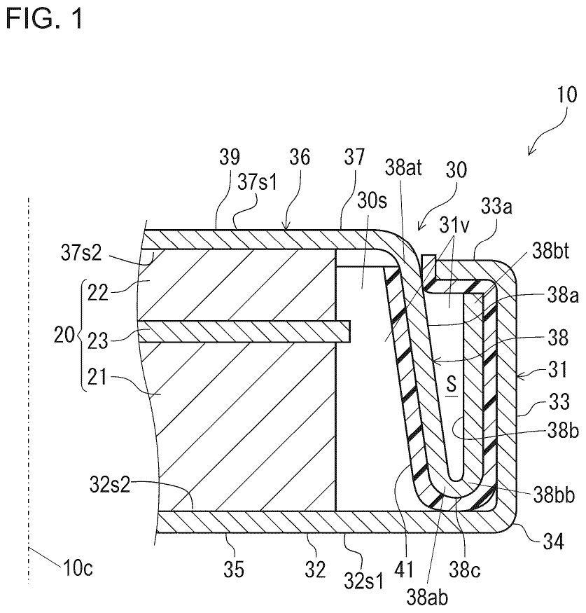

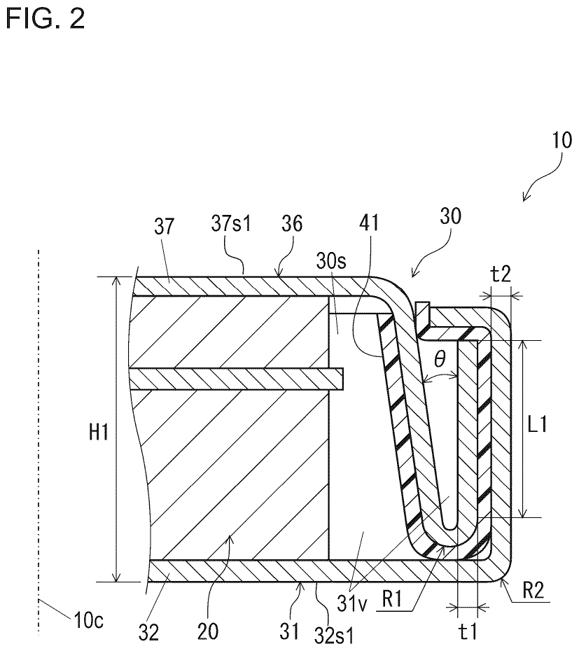

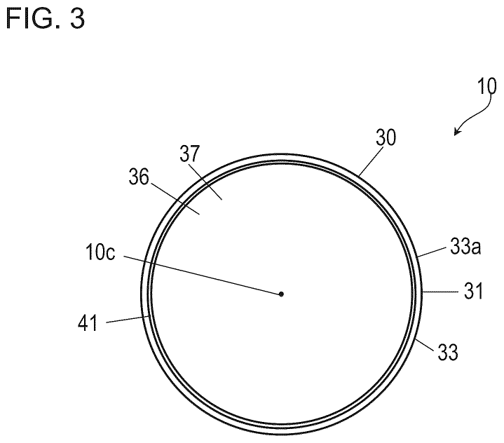

As illustrated in FIGS. 1 and 2, coin-shaped battery 10 according to the embodiment includes power generation element 20 and outer housing 30. FIGS. 1 and 2 show a cross section of coin-shaped battery 10 taken along line I-I shown in FIG. 3.

Power generation element 20 includes positive electrode 21, negative electrode 22, separator 23 interposed between the electrodes, and an electrolyte. Each of positive electrode 21 and negative electrode 22 is in a pellet form. Separator 23 is made of a porous material, such as a nonwoven fabric.

Outer housing 30 hermetically accommodates power generation element 20 in internal space 30s. Outer housing 30 includes case 31, sealing plate 36, and gasket 41. Outer housing 30 hermetically accommodates power generation element 20 therein with gasket 41 compressed between case 31 and sealing plate 36.

Case 31 includes bottom plate 32 and side wall 33 extending upward from the circumferential edge of bottom plate 32. As illustrated in FIG. 3, bottom plate 32 has a circular shape about central axis 10c. Bottom plate 32 and side wall 33 are formed unitarily in a single piece. Bent portion 34 is formed between bottom plate 32 and side wall 33. Tip end portion 33a of side wall 33 is bent radially inward toward central axis 10c. The outer surface of case 31 has first terminal surface 35. First terminal surface 35 is electrically connected to positive electrode 21 of power generation element 20 to function as a positive electrode terminal surface of coin-shaped battery 10. Case 31 is made of stainless steel.

Bottom plate 32 includes outside main surface 32s1 constituting a portion of terminal surface 35 and inside main surface 32s2 opposite to outside main surface 32s1. Bottom plate 32 and side wall 33 together surround and demarcate case internal space 31v.

Sealing plate 36 includes top plate 37 and circumferential edge portion 38 extending from top plate 37 toward inside with respect to side wall 33 of case 31. Top plate 37 has a circular shape about central axis 10c. Circumferential edge portion 38 of sealing plate 36 is closer to central axis 10c than side wall 33 of case 31. Top plate 37 and circumferential edge portion 38 are formed unitarily in a single piece. The outer surface of sealing plate 36 includes second terminal surface 39. Second terminal surface 39 is electrically connected to negative electrode 22 of power generation element 20 to function as a negative electrode terminal surface of coin-shaped battery 10. Sealing plate 36 is made of stainless steel.

Top plate 37 has outside main surface 37s1 constituting a portion of terminal surface 39 and inside main surface 37s2 opposite to outside main surface 37s1. Top plate 37 and circumferential edge portion 38 together surround and demarcate internal space 30s. Circumferential edge portion 38 extends toward inside with respect to side wall 33, that is, into case internal space 31v.

Gasket 41 is compressed and interposed between side wall 33 of case 31 and circumferential edge portion 38 of sealing plate 36. Gasket 41 is made of polypropylene. Gasket 41 is compressed between tip end portion 33a of side wall 33 and second wall portion 38b (described later). Gasket 41 is compressed between bottom plate 32 and fold-back portion 38c (described later).

Circumferential edge portion 38 of sealing plate 36 includes first wall portion 38a, second wall portion 38b, and fold-back portion 38c. First wall portion 38a, second wall portion 38b, and fold-back portion 38c are formed unitarily in a single piece.

First wall portion 38a extends from top plate 37 end toward bottom plate 32 end, that is, extends in a direction from top plate 37 toward bottom plate 32. First wall portion 38a extends toward an outside of coin-shaped battery 10, i.e., further away from central axis 10c toward side wall 33 of case 31 as extending from top plate 37 toward bottom plate 32. First wall portion 38a includes end portion 38at connected to top plate 37 and end portion 38ab opposite to end portion 38at. First wall portion 38a extends linearly from a connected location (end portion 38at) to top plate 37 to a connected location (end portion 38ab) to fold-back portion 38c. In other words, first wall portion 38a does not have a step shape at its middle part.

Second wall portion 38b is disposed outward with respect to first wall portion 38a, that is, disposed further away from central axis 10 and between first wall portion 38a and side wall 33 of case 31. Second wall portion 38b extends from bottom plate 32 end toward top plate 37 end, that is, extends in a direction from bottom plate 32 end 32 toward top plate 37. Second wall portion 38b compresses gasket 41 between second wall portion 38b and side wall 33 of case 31. Second wall portion 38b extends substantially parallel to side wall 33 of case 31.

Fold-back portion 38c connects first wall portion 38a to second wall portion 38b. Second wall portion 38b includes end portion 38bb connected to fold-back portion 38c and end portion 38bt opposite to end portion 38bb. More specifically, fold-back portion 38c connects end portion 38at first wall portion 38a facing bottom plate 32 and end portion 38bt of second wall portion 38b facing bottom plate 32. Fold-back portion is formed between first wall portion 38a and second wall portion 38b in the process of bending a plate to form first wall portion 38a and second wall portion 38b.

Space S is provided between first wall portion 38a and second wall portion 38b. When fold-back portion 38c is formed to provide the space, the above-mentioned springback occurs noticeably at that fold-back portion 38c. The springback causes gasket 41 to be compressed sufficiently over a wide region between second wall portion 38b and side wall 33. This configuration allows gasket 41 to be thin in accomplishing the hermetically sealed structure of coin-shaped battery 10. Before being compressed, gasket 41 according to the embodiment has a thickness less than thickness t1 of second wall portion 38b (see FIG. 2).

The compression rate of gasket 41 between second wall portion 38b and side wall 33 may be lower than the compression rate of gasket 41 between tip end portion 33a of side wall 33 and second wall portion 38b. The former compression rate is, for example, greater than or equal to 0.3 and less than or equal to 0.4. The latter compression rate is, for example, greater than or equal to 0.4 and less than or equal to 0.6.

The compression rate of gasket 41 between second wall portion 38b and side wall 33 is lower than the compression rate of gasket 41 between fold-back portion 38c and bottom plate 32. The former compression rate is, for example, greater than or equal to 0.3 and less than or equal to 0.4. The latter compression rate is, for example, greater than or equal to 0.4 and less than or equal to 0.6.

Next, dimensions of various parts of coin-shaped battery 10 will be described with reference to FIG. 2.

Thicknesses t1 of first wall portion 38a and second wall portion 38b is less than or equal to thicknesses t2 of bottom plate 32 and side wall 33. In accordance with the embodiment, thickness t1 is equal to thickness t2, but this is merely exemplary. For example, thickness t1 may be less than thickness t2. In addition, from the viewpoint of reducing the size of coin-shaped battery 10, the thicknesses preferably satisfy the relation t1×2>t2.

Radius of curvature R1 of the outer surface of fold-back portion 38c is greater than radius of curvature R2 of the outer surface of bent portion 34.

Angle θ formed by first wall portion 38a and second wall portion 38b is greater than or equal to 3° and less than or equal to 20°. Angle θ may be preferably greater than or equal to 5° and less than or equal to 20°, and more preferably, angle θ may be greater than or equal to 5° and less than or equal to 10°.

The battery satisfies the relation H1×0.4≤L1≤H1×0.8, where H1 is the distance, along a height direction (i.e., the height dimension of coin-shaped battery 10), between outside main surface 32s1 of bottom plate 32 and outside main surface 37s1 of top plate 37, and L1 is the length, along the height direction, of the part of gasket 41 that is compressed by side wall 33 and second wall portion 38b. The battery may preferably satisfy the relation, H1×0.65≤L1≤H1×0.75.

### INDUSTRIAL APPLICABILITY

The present disclosure is applicable to coin-shaped batteries.

### REFERENCE MARKS IN THE DRAWINGS

10 coin-shaped battery

20 power generation element

21 positive electrode (first electrode)

22 negative electrode (second electrode)

23 separator

30 outer housing

31 case

32 bottom plate

33 side wall

33a tip end portion

34 bent portion

35 first terminal surface

36 sealing plate

37 top plate

38 circumferential edge portion

38a first wall portion

38b second wall portion

38c fold-back portion

39 second terminal surface

41 gasket

H1 height dimension of coin-shaped battery

L1 height dimension of gasket compressed region

R1 outer surface radius of curvature of fold-back portion

R2 outer surface radius of curvature of bent portion

S space

t1 thickness of first wall portion and second wall portion

t2 thickness of bottom plate and side wall

θ angle formed by first wall portion and second wall portion

1. A coin-shaped battery comprising:
a power generation element; and
an outer housing hermetically accommodating the power generation element therein, wherein
the outer housing includes:
a case including a bottom plate and a side wall extending upward from the bottom plate, the case having an outer surface including a first terminal surface;
a sealing plate including a top plate and a circumferential edge portion extending from the top plate toward inside with respect to the side wall, the sealing plate having an outer surface including a second terminal surface; and
a gasket compressed and interposed between the side wall and the circumferential edge portion,
the circumferential edge portion includes:
a first wall portion extending in a direction from the top plate toward the bottom plate;
a second wall portion disposed outward with respect to the first wall portion, the second wall portion extending in a direction from the bottom plate toward the top plate such that the gasket is compressed between the second wall portion and the side wall; and
a fold-back portion connecting the first wall portion to the second wall portion,
a space is provided between the first wall portion and the second wall portion, and
a thickness of the gasket before compression is less than a thickness of the second wall portion.

2. The coin-shaped battery according to claim 1, wherein thicknesses of the first wall portion and the second wall portion is less than or equal to thicknesses of the bottom plate and the side wall.

3. The coin-shaped battery according to claim 1, wherein a radius of curvature of an outer surface of the fold-back portion is greater than a radius of curvature of an outer surface of a bent portion between the bottom plate and the side wall.

4. The coin-shaped battery according to claim 1, wherein an angle formed by the first wall portion and the second wall portion is greater than or equal to 3° and less than or equal to 20°.

5. The coin-shaped battery according to claim 1, wherein an expression H1×0.4≤L1≤H1×0.8 holds, where H1 is a distance, along a height direction, between an outside main surface of the bottom plate and an outside main surface of the top plate, and L1 is a length, along the height direction, of a part of the gasket compressed by the side wall and the second wall portion.

6. The coin-shaped battery according to claim 1, wherein a tip end portion of the side wall is bent inward such that the gasket is compressed between the tip end portion and the second wall portion.

7. The coin-shaped battery according to claim 6, wherein a compression rate of the gasket between the second wall portion and the side wall is lower than a compression rate of the gasket between the tip end portion of the side wall and the second wall portion.

8. The coin-shaped battery according to claim 1, wherein:
the gasket is compressed between the fold-back portion and the bottom plate, and
a compression rate of the gasket between the second wall portion and the side wall is lower than a compression rate of the gasket between the fold-back portion and the bottom plate.
